(19) United States
(12) Patent Application Publication
(10) Pub. No.: US 2007/0118492 A1
(43) Pub. Date: May 24, 2007

(54) Variational sparse kernel machines

(76) Inventors: Claus Bahlmann, Princeton, NJ (US); Paolo Favaro, Edinburgh (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/599,563

(22) Filed: Nov. 14, 2006

Related U.S. Application Data
(60) Provisional application No. 60/738,233, filed on Nov. 18, 2005.

(51) Int. Cl. G06F 15/18

(52) U.S. Cl. 706/20

(57) ABSTRACT

A computer-implemented method for supervised learning for classification that unifies generative and discriminative methods in a variational framework includes providing training data for determining a classifier, defining a cost functional based on a kernel density, finding a function of the cost functional by searching for a zero crossing of joint probabilities for a label for a given data point, optimizing the cost functional using a gradient descent, and outputting the classifier comprising an optimized cost functional for classifying data.

This application claims the benefit of Provisional Application No. 60/738,233 filed on Nov. 18, 2005 in the United States Patent and Trademark Office, the contents of which are herein incorporated by reference in its entirety.

### BACKGROUND OF THE INVENTION

1. Field of the Invention

The present disclosure relates to supervised learning, and more particularly to a system and method for supervised learning for classification that unifies generative and discriminative methods in a variational framework.

2. Description of Related Art

One of the most significant approaches to machine learning to emerge in recent years is the Support Vector Machine (SVM), which follows a discriminative classification paradigm. The SVM is based on Vapnik's structural risk minimization principle. This criterion attempts to fit the training data while at the same time minimize the “complexity” of the classifier.

Similar ideas are incorporated in Relevance Vector Machine (RVM) classifiers, which in addition aim at a sparse solution. This, in theory, enables fast classification. Learning is, however, a demanding task, and yet not solved for many difficult problems.

It should be noted that for SVM reduced set methods exist that subsequently prune support vectors to reduce the number of kernels needed at the expense of some increase in error.

An alternative to discriminative classification, generative classification ideas are valuable, typically when the classification task needs the output of confidences or classification probabilities within a larger framework. Hidden Markov models are the basis of many large-scale speech recognition engines, where a probabilistic reasoning based on language models is needed.

Therefore, a need exists for a system and method for supervised learning for classification that unifies generative and discriminative methods in a variational framework.

### SUMMARY OF THE INVENTION

According to an embodiment of the present disclosure, a computer-implemented method for supervised learning for classification that unifies generative and discriminative methods in a variational framework including providing training data for determining a classifier, defining a cost functional based on a kernel density, finding a function δ of the cost functional by searching for a zero crossing of joint probabilities p(γ=0|X)−p(γ=1|X), wherein γ is a label for a given data point X, optimizing the cost functional using a gradient descent, And outputting the classifier comprising-an optimized cost functional for classifying data.

According to an embodiment of the present disclosure, a computer-implemented method for classification that unifies generative and discriminative methods in a variational framework including providing a trained classifier, providing data to be classified, and classifying the data to be classified using the trained classifier comprising a cost functional implementing a simultaneous mixed generative and discriminative determination.

According to an embodiment of the present disclosure, a computer readable media embodying instructions executable by a processor to perform a method for supervised learning for classification that unifies generative and discriminative methods in a variational framework is provided. The method including providing training data for determining a classifier, defining a cost functional based on a kernel density, finding a function δ by searching for a zero crossing, optimizing the cost functional using a gradient descent according to the function δ, and outputting the classifier comprising an optimized cost functional for classifying data. The method may further include performing a classification comprising providing a trained classifier, providing data to be classified, and classifying the data to be classified using the trained classifier comprising a cost functional implementing a simultaneous mixed generative and discriminative determination.

### BRIEF DESCRIPTION OF THE DRAWINGS

Preferred embodiments of the present invention will be described below in more detail, with reference to the accompanying drawings:

FIG. 1 is an illustration of a variational sparse kernel machine according to an embodiment of the present disclosure;

FIGS. 2A and 2E show kernel density estimates for XOR and spiral problems, respectively, according to an embodiment of the present disclosure;

FIGS. 2B-D and 2F-H show sparse kernel density progressions for XOR and spiral problems, respectively, according to an embodiment of the present disclosure;

FIGS. 3A and 3E show the boundary obtained from kernel density estimates for XOR and spiral problems, respectively, according to an embodiment of the present disclosure;

FIGS. 3B-D and 3F-H show sparse kernel boundary progressions for XOR and spiral problems, respectively, according to an embodiment of the present disclosure;

FIGS. 4A and 4B are flow charts of a method for determining a classifier according to an embodiment of the present disclosure; and

FIG. 5 is a diagram of a computer-system for determining a classifier according to an embodiment of the present disclosure.

### DETAILED DESCRIPTION OF PREFERRED EMBODIMENTS

According to an embodiment of the present disclosure, a method for supervised learning for classification unifies generative and discriminative methods in a variational framework. The method defines a cost functional based on a kernel density estimate (KDE) of the training data, and a decision boundary. This cost functional is minimized by estimating a function in the form of a linear combination of kernels, a sparse kernel machine. Despite the variational formulation, it is shown that the complexity of the optimization problem can be reduced since the proposed cost functional can be computed analytically. As a result, training is computationally efficient. The method has been tested with a number of data sets and illustrate its performance on classification tasks.

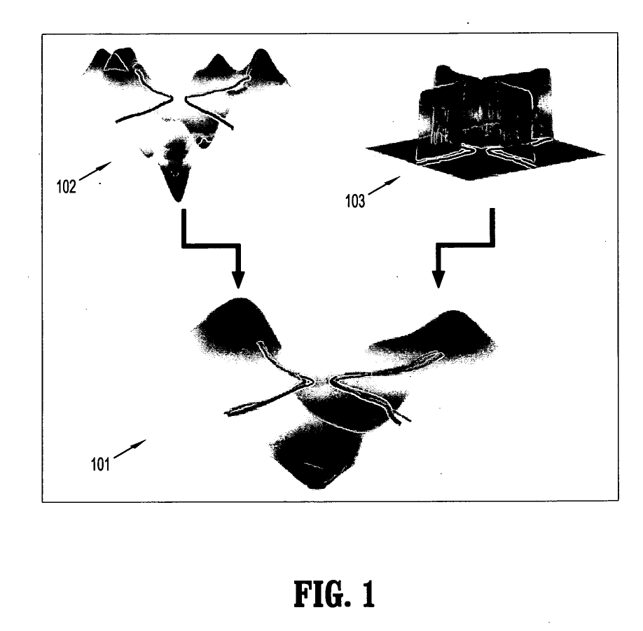

In supervised learning training data is given in the form of a set of input vectors Xᵢ∈ [symbol] and associated labels γᵢ∈Y with i=1 . . . M, to make predictions of γ for new input vectors X. Depending on whether the space Y is finite or not, the task is either called classification or regression respectively. In the problem of classification where Y={0,1}, i.e., where the labels γᵢ are of binary nature, generative and discriminative approaches may be used. Generative approaches are based on learning a model of the joint probability, p(X,γ), or equivalently the class conditional density, p(X|γ), of the inputs X and γ, and making a prediction by using Bayes rule to calculate p(γ|X), and estimating a classifier that picks the most likely parameter γ. Discriminative approaches are designed to infer the class mapping with help of some sort of discriminant function. Discriminative classifiers often achieve higher test set accuracy than generative classifiers at the price of making ‘hard’ binary decisions that are not associated to any probability measure. Generative classifiers have the advantage of being specifically designed to return a decision and the associated probability measure. In an effort to obtain the benefits of both methods, a method for supervised learning is implemented to estimate a classifier, a variational sparse kernel machine (FIG. 1). The variational sparse kernel machine (101) is estimated by simultaneously matching kernel density classifier (102) and decision boundary (103). The variational sparse kernel machine (101) yields a probability associated to the decision while substantially preserving a given decision boundary. To obtain the variational sparse kernel machine 101, a method approaches the problem of estimating the classifier as a variational framework so that it is possible to explicitly specify how discriminative (103) and generative (102) an estimated classifier should be. The KDE of the training set combined with the explicit representation of both decision boundary and estimated classifier as a mixture of radial basis kernels, allows one to solve the cost functional in analytic form.

Classification and Confidence Measure

According to an embodiment of the present disclosure, to recover a function g: [symbol] [symbol] Y, a classifier predicts a label γ given a data point X. If the pairs {X,γ} are associated to a probability density p(X,γ), then one can choose g such that

$$g ( X ) = arg {max}_{γ ∈ 𝒴} p ( X , γ ) = arg {max}_{γ ∈ 𝒴} p ( γ \vert X ) . \qquad ( 1 )$$

This choice for g is a Bayes classifier, which can be obtained as a solution of risk minimization where incorrect labels are penalized for a certain choice of weights. Typically, a finite set of pairs {Xᵢ,γᵢ}_{i=1 . . . M}, and the training data are provided, while the probability density p(X,γ) and the conditional probability density p(X|γ) are unknown. Since the Bayes classifier can be arbitrarily complex, training data may not be sufficient to uniquely identify the probability density p(X,γ) or p(γ|X), and therefore, the recovery of the classifier g is an ill-posed problem; a problem is ill-posed when a solution does not exist, it is not unique or a small variation in the input data causes large variations in an output—stability. Coping with the ill-posedness of the problem is a difficult task; however, in many applications, it may be useful to render a stable estimation of g. One way to do so is to introduce regularization during the estimation of g. This can be formulated in an energy minimization setting by introducing additional terms that are devoted to constraining the solution to belong to a certain manifold or, by explicitly parameterizing g or p(γ|X).

Before describing the details of how to carry out the minimization task, an aspect of the classification problem should be noted: When predicting a label γ for a given data point X, it is important to also have the likelihood p(γ|X). Indeed, if the choice of a label γ is supported by a large p(γ|X), then one can make a decision with high confidence as opposed to the case when p(γ|X) is uniform in γ, where any choice is arbitrary. The likelihood p(γ|X) is a confidence measure. The lone classifier g may not provide such information, unless one explicitly parameterizes g as a function of the confidence measure as in eq. (1) and recovers p(γ|X). According to an embodiment of the disclosure, a confidence measure is output, therefore this strategy is followed and the problem of estimating p(γ|X) may be posed as the following minimization problem:

$$\hat{p} ( γ \vert X ) = arg {min}_{\tilde{p} ( γ \vert X )} \int Ψ ( p ( γ \vert X ) , \tilde{p} ( γ \vert X ) ) p ( X , γ ) ⅆ X ⅆ γ \qquad ( 2 )$$

where ψ is a cost functional (e.g., the Kullback-Leibler pseudo-distance or an Lₚ norm). As only a finite data set {Xᵢ,γᵢ}_{i=1 . . . M} is available, the following approximation may be used:

$$\hat{p} ( γ \vert X ) = arg {min}_{\tilde{p} ( γ \vert X )} \frac{1}{M} {\sum }_{i = 1}^{M} Ψ ( p ( {γ}_{i} \vert {X}_{i} ) , \tilde{p} ( {γ}_{i} \vert {X}_{i} ) ) . \qquad ( 3 )$$

This approximation is accurate for a large number of samples, and the needed size of the training set increases with the dimension of the space [symbol] . One way to cope with the limitation of the available data is to use the KDE of the probability density of the training data, as described below. Then, rather than using eq. (3), one can substitute p(X,γ) (and p(γ|X)) with the corresponding KDE approximation q(X,γ) (and

$$\frac{q ( X , γ )}{{\sum }_{x} q ( X , γ )}$$

respectively) directly into eq. (2) and solve for \hat{p}(γ|X). This results in

$$\hat{p} ( γ \vert X ) = arg {min}_{\tilde{p} ( γ \vert X )} \int {( q ( γ \vert X ) - \tilde{p} ( γ \vert X ) )}^{2} q ( X , γ ) ⅆ X ⅆ γ \qquad ( 4 )$$

where we chose the discrepancy function ψ to be the L₂ norm. Eq. (4) forms the basis of the approach.
Estimating Confidence: Generative vs. Discriminative Approaches

The problem of finding a classifier g and a confidence measure \hat{p}(γ|X) can be posed by minimizing eq. (4). This optimization problem corresponds to a discriminative approach, as the method estimates p(γ|X). The optimization procedure emphasizes the decision boundary as the probability density p(γ|X) tends to be “flat” away from it. Indeed, in many cases, p(γ|X) resembles a smooth step function when parameterized with respect to X. If one poses the alternative problem of estimating

$$\hat{p} ( γ \vert X ) = arg {min}_{\tilde{p} ( γ \vert X )} \int {( q ( X \vert γ ) - \tilde{p} ( X \vert γ ) )}^{2} q ( X , γ ) ⅆ X ⅆ γ \qquad ( 5 )$$

then the emphasis would be larger in regions away from the decision boundary. This latter minimization corresponds to the generative paradigm where the solution is an estimate of p(X|γ).

According to an embodiment of the present disclosure, one can explicitly regulate the emphasis on the decision boundary and on the inner regions. The method linearly combines both terms into a single minimization problem as follows:

$$\hat{p} ( X \vert γ ) = arg {min}_{\tilde{p} ( X \vert γ )} \int {( q ( X \vert γ ) - \tilde{p} ( X \vert γ ) )}^{2} \cdot ( q ( X , γ ) + {μ}_{0} δ ( X , γ ) ) ⅆ X ⅆ γ \qquad ( 6 )$$

where μ₀ is a scalar parameter that regulates how discriminative the solution will be, and δ: [symbol] ×Y [symbol] [0,∞) is a function that emphasizes the decision boundary.

Once \hat{p}(X|γ) has been estimated, \hat{p}(γ|X) is recovered via Bayes rule as

$$\hat{p} ( γ \vert X ) = \frac{\hat{p} ( X \vert γ ) p ( γ )}{{\sum }_{γ ∈ 𝒴} \hat{p} ( X \vert γ ) p ( γ )} \qquad ( 7 )$$

and the classifier g is obtained from eq. (1).

Thus, the method includes a confidence measure \hat{p}(γ|X) associated to a classifier g, wherein the confidence measure can be selectively constrained to be more discriminative or generative depending on the classification problem at hand. Further, the cost functional in eq. (6) can be computed in analytic form for a certain choice of representation of the various terms. This will enable an efficient training procedure. Detection can be made fast by using a sparse kernel representation for our solution \hat{p}(X|γ).

Kernel Density Estimation

As described herein, one is typically not given the joint probability p(γ,X) and, hence, the joint probability p(γ,X) needs to be estimated from a set of data samples {Xᵢγᵢ, }_{i=1 . . . M}. Methods to solve such task can be divided into parametric and nonparametric ones. Parametric methods provide a sparse data representation, but are typically based on assumptions that are too restrictive. Nonparametric methods make use of fewer assumptions, but their representation uses the entire data set, which makes them memory demanding. Nonparametric methods are described herein as a general example of estimating the joint probability p(γ,X). The nonparametric methods obtain a KDE q(X,γ) of p(X,γ) as a sum of kernels k: [symbol] [symbol] [0,∞), each of which is located at a data point of the training set. If the kernels depend only on the norm of their argument, then the KDE approximation q(X,γ) of p(X,γ) takes the form

$$q ( X \vert γ ) = \frac{1}{N} {\sum }_{n \vert {γ}_{n} = γ} k ( ‖ X - {X}_{n} ‖ ) \qquad ( 8 )$$

where N is the number of samples such that γₙ=γ∀n=1 . . . M. A number of different kernels may be used depending on the problem at hand. For example, radial basis functions, i.e., Gaussian kernels, may be used. In particular, consider Gaussian kernels with isotropic covariances Σₙ=σₙ²I, where I denotes the identity matrix in the space [symbol] . Thus, eq. (8) becomes

$$q ( X \vert γ ) = \frac{1}{N} {\sum }_{n \vert {γ}_{n} = γ} k ( X ; {X}_{n} , {σ}_{n}^{2} ) , \qquad ( 9 )$$

with mean Xₙ and variance σₙ², which can be written in shorthand notation as
q(X|γ)=ζ(γ)^{T}k(X) (10)
where ζ(γ)=[ζ(γ)₁, . . . , ζ(γ)_{M}]^{T} with

$${ζ ( γ )}_{n} = \{ \begin{matrix}\frac{1}{N} & γ = {γ}_{n} \\ 0 & otherwise\end{matrix} ∀ n = 1 … M \qquad ( 11 )$$

and
k(X)=[k(X;X₁,σ₁²), . . . , k(X;X_{M},σ_{M}²)]^{T}. (12)
The KDE q(X|γ) amounts to choosing the covariances {σₙ²}_{n=1 . . . M} of the radial basis k(X) (also referred to as the bandwidth). This task can be performed by standard methods in the literature, for example, the “plug-in” method, which estimates the optimal covariance by minimizing the asymptotically mean integrated squared error (AMISE).

Since the task is to estimate the confidence measure p(γ|X), the KDE q(X|γ) can be used directly after applying Bayes rule. Notice that while the confidence measure obtained from the KDE would be highly accurate, it is memory demanding as all the training samples need to be employed in the representation, and it is computationally intensive during prediction. Its performance scales with the number of training samples M. To overcome these disadvantages, eq. (6) may be solved by seeking for a sparse approximation of the KDE which yields the variational sparse kernel machines, as described below.

Variational Sparse Kernel Machines

According to an embodiment of the present disclosure, the method uses an explicit representation of the solution \hat{p}(X|γ) of eq. (6). This representation serves a number of purposes, including regularizing the estimation problem, making the classifier computationally efficient during prediction, providing a classifier with low memory demands, and forming the basis for the computation of eq. (6) in analytic form.

Writing \hat{p}(X|γ) as

$$\begin{matrix}\hat{p} ( X \vert γ ) = {\sum }_{m = 1}^{S} {α}_{m} h ( X ; {V}_{m} ; {σ}_{m}^{2} ) \\ = {α}^{T} h ( X ; V , {σ}^{2} ) .\end{matrix} \qquad ( 13 )$$

where
α=[α₁, . . . , α_{S}]^{T} (14)
and
h(X;V,σ²)=[h(X;V₁,σ₁²), . . . , h(X;V_{S},σ_{S}²)]^{T} (15)
for S<<M—a compressed approximation of the KDE q(X|γ) may be determined by minimizing eq. (6). Given an explicit representation of \hat{p}(X|γ), a solution may be identified by parameters α, V and σ². Furthermore, to guarantee that the estimated function is a valid probability density in X, it is imposed that
αₘ≧0∀m=1 . . . S (16)
and that

$${\sum }_{m = 1}^{S} {α}_{m} = 1. \qquad ( 17 )$$

The first constraint (eq. (16)) can be achieved by using an exponential map so that each αₘ is parameterized in λₘ as
αₘ=e^{λm}. (18)
The second constraint (eq. (17)) can be achieved by adding the following term as a soft constraint in eq. (6):

$${{μ}_{1} ( {\sum }_{m = 1}^{S} {α}_{m} - 1 )}^{2} \qquad ( 19 )$$

Now, to form the basis for the computation of eq. (6) in analytic form, h is chosen to be composed of Gaussian kernels as done for the KDE q(X|γ), i.e. h=k. Similarly, the same choice of representation is made for the boundary function δ. Now, all the explicit representations are substituted for the various terms in eq. (6), an equation including the following product of Gaussians in X and V is obtained:
k(X;Vₘ;σₘ²)k(X;Vⱼ;σⱼ²)k(X;Xᵢ;σᵢ²) (20)
and
k(X;Vₘ;σₘ²)k(X;Xⱼ;σⱼ²)k(X;Xᵢ;σᵢ². (21)
It can be shown that the integral in X of each of such product of Gaussians is again a product of two Gaussians evaluated at some combination of the data points Xᵢ and/or the vectors Vₘ. For example, eq. (20) yields

$$k ( {V}_{m} ; {V}_{j} ; {σ}_{m}^{2} + {σ}_{j}^{2} ) k ( {X}_{i} ; \frac{{V}_{m} {σ}_{j}^{2} + {V}_{j} {σ}_{m}^{2}}{{σ}_{j}^{2} + {σ}_{j}^{2}} ; \frac{{σ}_{m}^{2} {σ}_{j}^{2}}{{σ}_{j}^{2} + {σ}_{j}^{2}} + {σ}_{i}^{2} ) . \qquad ( 22 )$$

An analytic form of the integral (6) can be obtained when the chosen kernels are Gaussians. This enables the determination of analytic forms for the gradients of the cost functional (6) with respect to the unknowns. Further, the minimization may be performed by gradient descent in an efficient way, an example of which is disclosed below. The sparseness of the explicit representation of \hat{p}(X|γ) and the method used to recover its parameters, provides the motivation to call this solution variational sparse kernel machines.
Estimating Sparse Kernel Machines

The method includes an estimate of the free parameters \hat{α}, \hat{V} and \hat{σ}² that minimize eq. (6). The variational nature of the formulation is exploited by employing a steepest gradient descent. The gradient ∇Ε of the cost functional Ε is determined as

$$E = \int {( q ( X \vert γ ) - \tilde{p} ( X \vert γ ) )}^{2} \cdot ( q ( X , γ ) + {μ}_{0} δ ( X , γ ) ) ⅆ X ⅆ γ + {{μ}_{1} ( {\sum }_{m = 1}^{S} {α}_{m} - 1 )}^{2} \qquad ( 23 )$$

with respect to each unknown and the following set of equations are evolved
λ(t+1)=λ(t)−_{ε}∇_{λ}Ε
σ(t+1)=σ(t)−_{ε}∇_{σ}Ε
V(t+1)=V(t)−_{ε}∇_{V}Ε (24)
for the steepest choice of ε. Although this method is guaranteed to minimize the cost functional Ε, since it is a local method, it may converge to a local minimum. Hence, the parameters need to be initialized not too far away from the global minimum. To do so, a clustering algorithm is used that provides an initial estimate of the centers of the Gaussians as well as their spreads σ and the parameters λ.
Enhancing the Decision Boundary

A function δ was introduced above that is devoted to emphasize the decision boundary. This function is represented by a sum of Gaussians. In the case of binary classification, it is immediate to define the decision boundary as the locations X where p(γ=0|X)=p(γ=1|X). One can obtain sample-locations from the decision boundary by considering all possible pairs of data points and by searching for the zero of p(γ=0|X)−p(γ=1|X) along the segment joining a pair.

Experiments

To illustrate a method for classification according to an embodiment of the present disclosure, and to show its suitability to challenging classification problems a number of simulations are shown in the following.

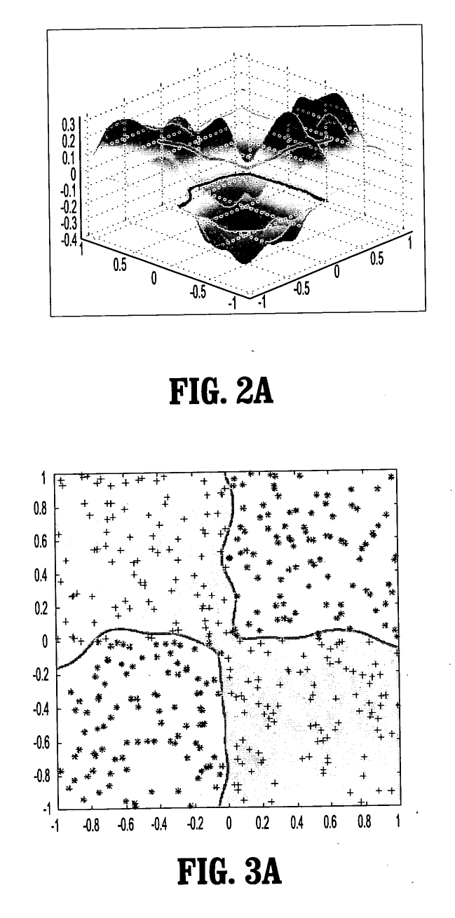

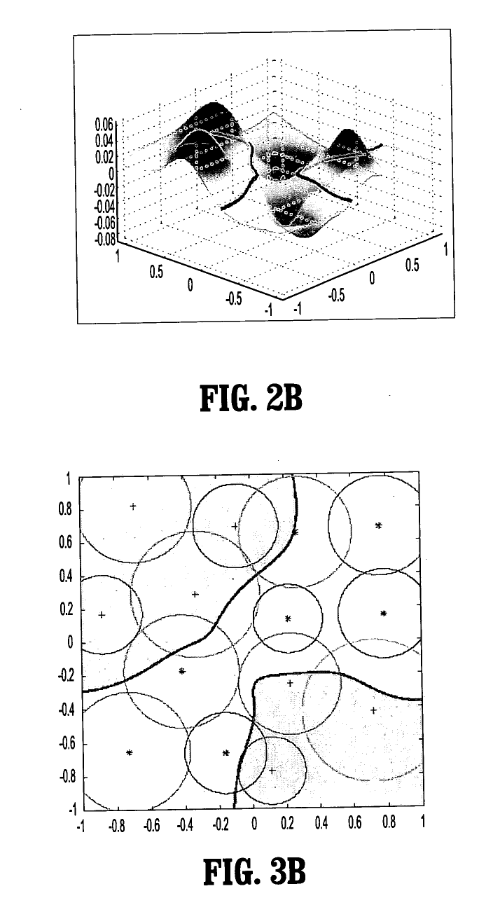

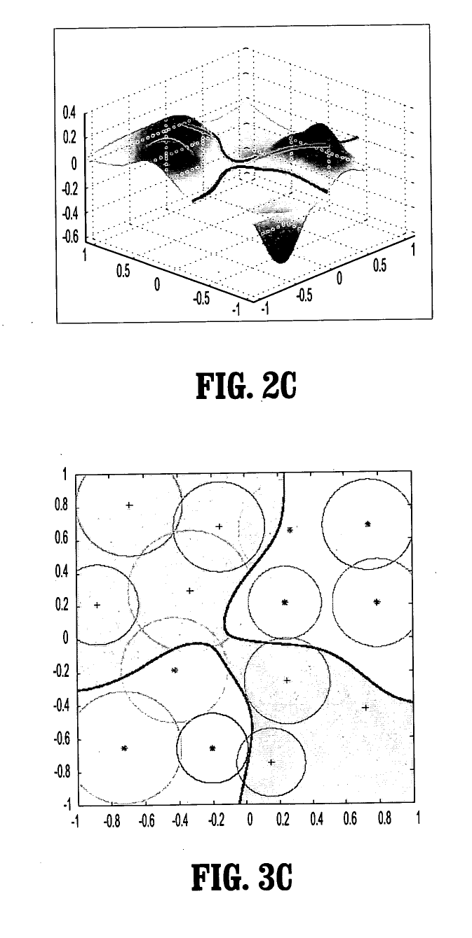

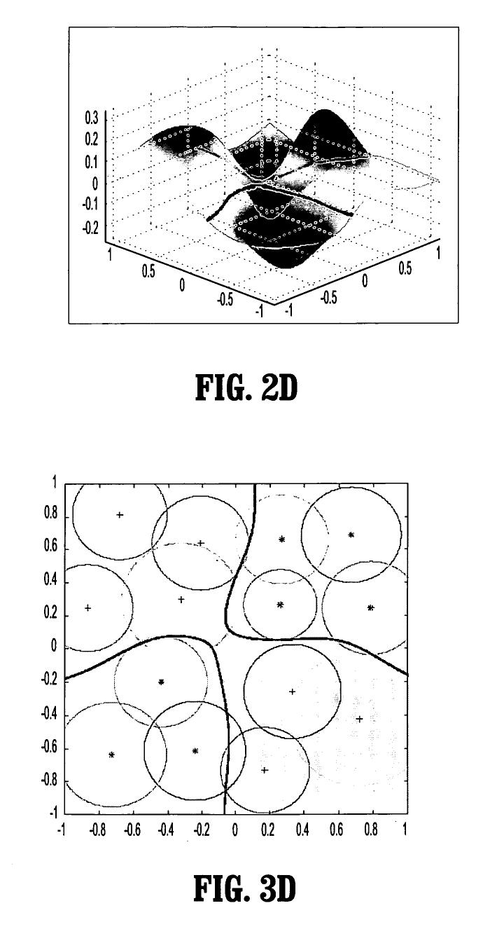

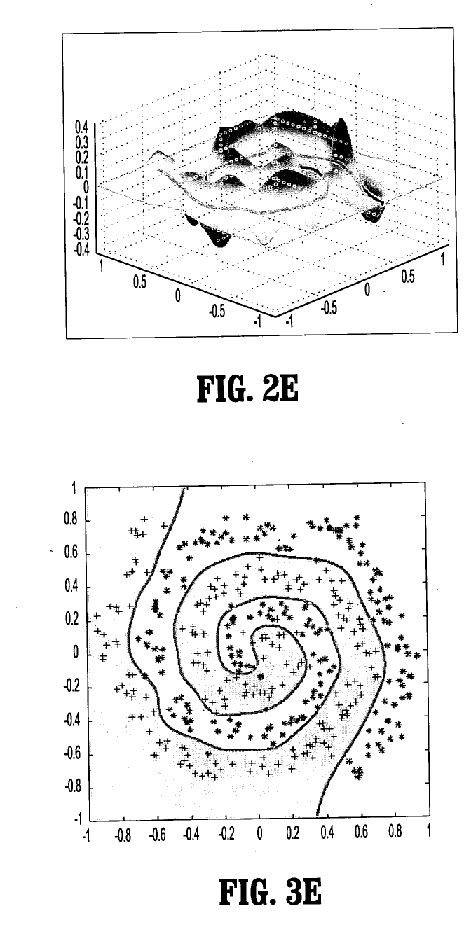

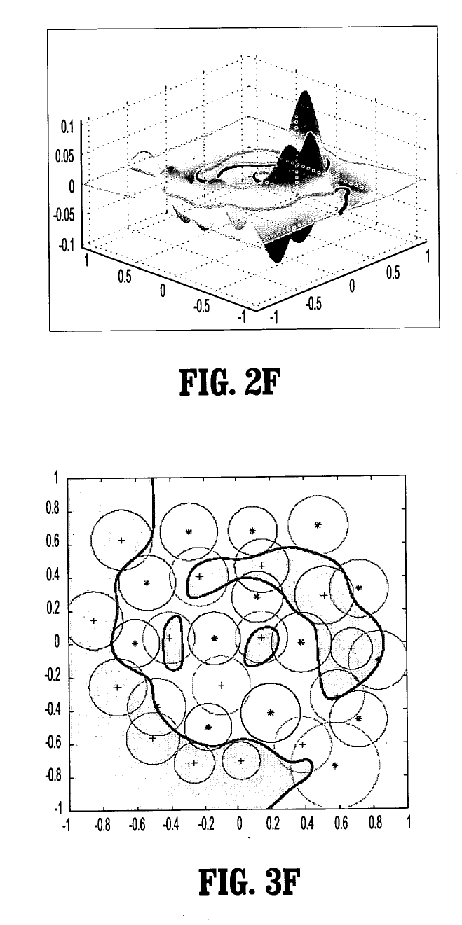

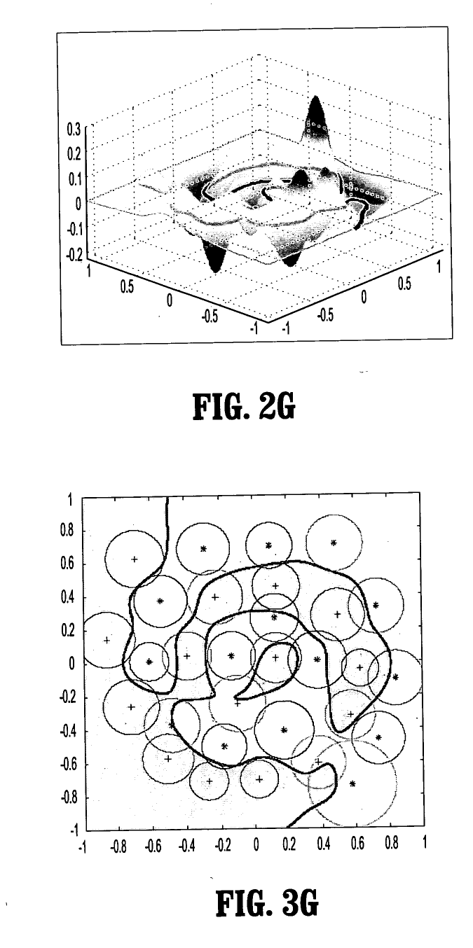

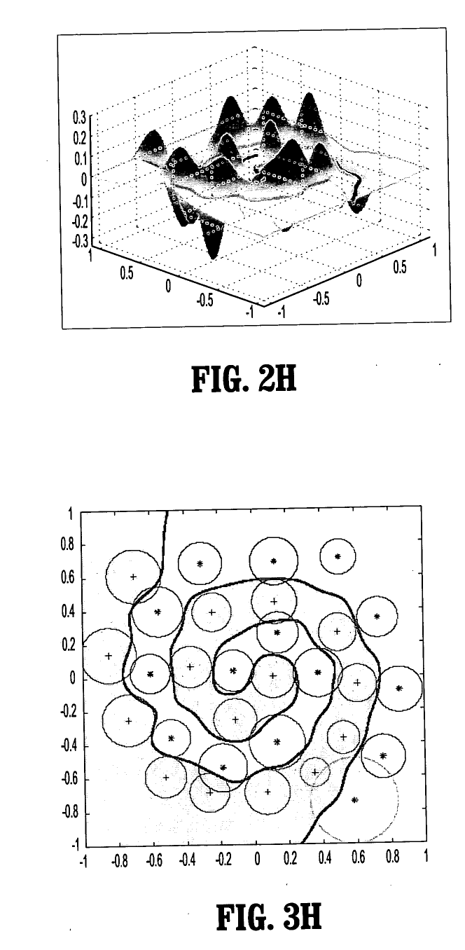

As a first example, consider the “XOR” problem—FIGS. 2A-D and FIG. 3A-D show the behavior of the classifier in this setting. FIG. 2A illustrates the KDE based difference q(X|γ₁)−q(X|γ₂) for the two classes γ₁=* and γ₂=+, the distribution of which is plotted in FIG. 3A. In this formulation, the decision boundary is located at the zero crossing. Its estimate based on the KDE is shown with a black line in FIG. 2A, FIG. 3A shows the two class regions with the use of two colors.

FIGS. 2B-D and FIGS. 3B-D show an example of the evolution of our method. FIGS. 2B-D and 3B-D, and FIGS. 2F-H and 3F-H correspond to the training after 1, 3, and 5 iterations, respectively. FIGS. 2A-D show the sparse kernel density difference \hat{p}(X|γ₁)−\hat{p}(X|γ₂), FIGS. 3A-D show the feature space partitioning based on the current iteration. In addition, mean vectors Vm, standard deviation σm, and mixing parameters αm of the 14 sparse kernels are illustrated by means of center, radius, and hue value of the displayed circle, respectively.

It can be clearly seen that, given a reasonable initialization, the learning algorithm converges to a close approximation of the KDE classifier. In the experiments, the initialization was taken from hierarchical clustering. It can be concluded from FIG. 2D and 3D that errors in the estimate are mostly confined to the peaks of q(X|γ₁)−q(X|γ₂), rather than near the boundary, as implied by formulation of our error functional.

FIGS. 2H and 3H show the same illustration for the “spiral” problem. Also here, the proposed learning converges close to the KDE boundary. Errors in the approximation of q(X|γ₁)−q(X|γ₂) can mostly be found at the distribution's peaks.

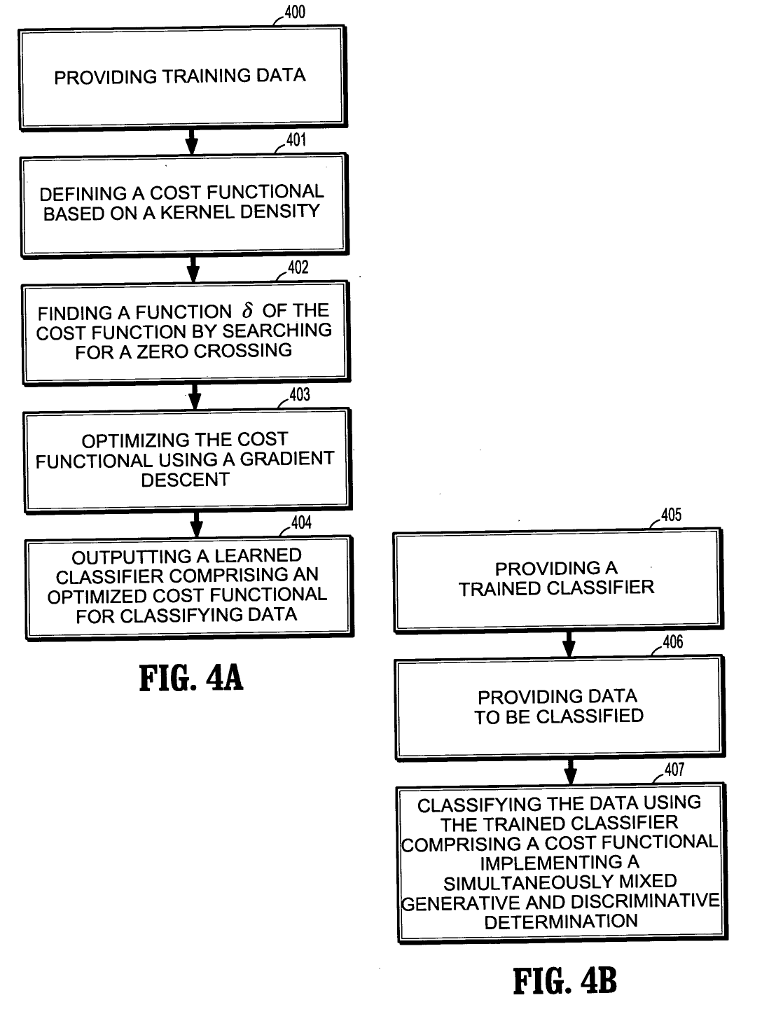

Referring to FIGS. 4A and 4B, according to an embodiment of the present disclosure, a computer-implemented method for supervised learning for classification that unifies generative and discriminative methods in a variational framework including providing training data for determining a classifier (400), defining a cost functional based on a kernel density (401), finding a function δ of the cost functional by searching for a zero crossing of joint probabilities p(γ=0|X)−p(y=1|X), wherein γ is a label for a given data point X (402), optimizing the cost functional using a gradient descent (403), And outputting the classifier comprising an optimized cost functional for classifying data (404). A computer-implemented method for classification that unifies generative and discriminative methods in a variational framework including providing a trained classifier (405), providing data to be classified (406), and classifying the data to be classified using the trained classifier comprising a cost functional implementing a simultaneous mixed generative and discriminative determination (407).

Exemplary implementations of the classifier may perform feature space analysis, and pattern recognition, and more particularly speech recognition, face detection, and object detection.

According to an embodiment of the present disclosure, a system and method for supervised learning for the purpose of classification exploits the advantages of generative and discriminative methods in a variational framework. A sparse representation of a confidence measure is recovered by means of a mixture of radial basis functions. The estimate of the confidence measure is a variational sparse kernel machine. The system and method regularize the estimation problem, make classifier computationally efficient during prediction, wherein the classifier will be not memory demanding, and the computation of eq. (6) can be carried out in analytic form.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

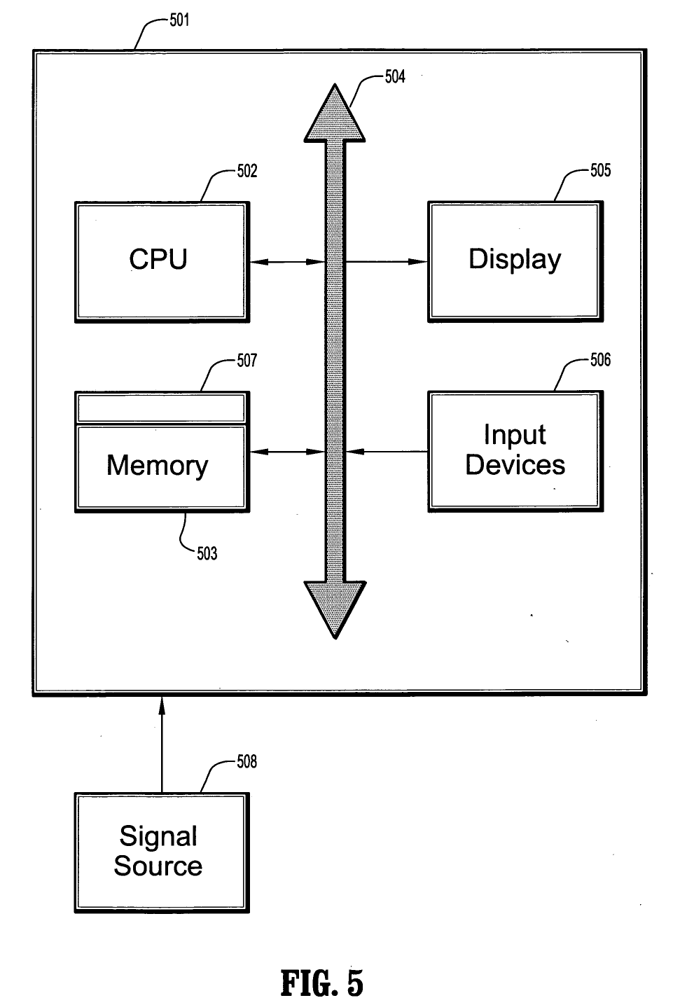

Referring to FIG. 5, according to an embodiment of the present disclosure, a computer system 501 for supervised learning for classification that unifies generative and discriminative methods in a variational framework can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 that is stored in memory 503 and executed by the CPU 502 to process the signal from the signal source 508. As such, the computer system 501 is a general-purpose computer system that becomes a specific purpose computer system when executing the routine 507 of the present invention.

The computer platform 501 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a system and method for supervised learning for classification that unifies generative and discriminative methods in a variational framework, it is noted that modifications and variations can be made by persons skilled in the art in light of the above teachings. It is therefore to be understood that changes may be made in embodiments of the present disclosure that are within the scope and spirit thereof.

What is claimed is:

1. A computer-implemented method for supervised learning for classification that unifies generative and discriminative methods in a variational framework comprising:
providing training data for determining a classifier;
defining a cost functional based on a kernel density;
finding a function δ of the cost functional by searching for a zero crossing of joint probabilities p(γ=0|)−p(γ=1|X), wherein γ is a label for a given data point X;
optimizing the cost functional using a gradient descent; and
outputting the classifier comprising an optimized cost functional for classifying data.

2. The computer-implemented method of claim 1, further comprising initializing the gradient descent using a clustering technique.

3. The computer-implemented method of claim 1, wherein finding the function δ by search for the zero crossing comprises obtaining sample-locations from a decision boundary by considering possible pairs of data points and by searching for a zero of the joint probabilities p(γ=0|X)−p(γ=1|X) along a segment joining each pair, wherein γ is the label for the given data point X.

4. The computer-implemented method of claim 1, wherein the classifier predicts a label γ given a data point X.

5. A computer-implemented method for classification that unifies generative and discriminative methods in a variational framework comprising:
providing a trained classifier;
providing data to be classified; and
classifying the data to be classified using the trained classifier comprising a cost functional implementing a simultaneous mixed generative and discriminative determination.

6. The computer-implemented method of claim 5, further comprising outputting a confidence of a classification of the data.

7. The computer-implemented method of claim 5, wherein the mixed generative and discriminative determination is explicit as a mixture of radial basis kernels.

8. The computer-implemented method of claim 5, wherein the data is classified into one of a plurality of classes learned by the trained classifier.

9. A computer readable media embodying instructions executable by a processor to perform a method for supervised learning for classification that unifies generative and discriminative methods in a variational framework, the method steps comprising:
providing training data for determining a classifier;
defining a cost functional based on a kernel density;
finding a function δ of the cost functional by searching for a zero crossing of joint probabilities for a label for a given data point;
optimizing the cost functional using a gradient descent; and
outputting the classifier comprising an optimized cost functional for classifying data.

10. The method of claim 9, further comprising initializing the gradient descent using a clustering technique.

11. The method of claim 9, wherein finding the function δ by search for the zero crossing comprises obtaining sample-locations from a decision boundary by considering possible pairs of data points and by searching for a zero of the joint probabilities p(γ=0|X)−p(γ=1|X) along a segment joining each pair, wherein γ is the label for the given data point X.

12. The method of claim 9, wherein the classifier predicts the label γ given the data point X.

13. The method of claim 9, further comprising performing a classification comprising:
providing a trained classifier;
providing data to be classified; and
classifying the data to be classified using the trained classifier comprising a cost functional implementing a simultaneous mixed generative and discriminative determination.

14. The method of claim 13, further comprising outputting a confidence of a classification of the data.

15. The method of claim 13, wherein the mixed generative and discriminative determination is explicit as a mixture of radial basis kernels.

16. The method of claim 13, wherein the data is classified into one of a plurality of classes learned by the trained classifier.
